(19) United States
(12) Patent Application Publication
(10) Pub. No.: US 2020/0159518 A1
(43) Pub. Date: May 21, 2020

(54) UPDATE OF EQUIPMENT FIRMWARE AND/OR CONFIGURATIONS FOR AN ELECTRIC DISTRIBUTION GRID

(71) Applicant: ELECTRICITE DE FRANCE, Paris (FR)

(72) Inventor: Maxime Gillaux, Boulogne Billancourt (FR)

(21) Appl. No.: 16/617,710

(22) PCT Filed: May 17, 2018
(86) PCT No.: PCT/EP2018/062957

§ 371 Date: Nov. 27, 2019

(30) Foreign Application Priority Data
May 30, 2017 (FR) 1754758

(51) Int. Cl. G06F 8/65; H04L 29/08

(52) U.S. Cl. CPC G06F 8/65; G06Q 50/06; H04L 67/125; H04L 67/34

(57) ABSTRACT

The invention relates to updating software intended to be executed by equipment of an electrical distribution grid, where each equipment unit forms a node of a command-control network communicating with other nodes of this command-control network. In particular it provides: a first step in which the respective priorities for updating are assigned to the nodes of the command-control networks; and a second step in which all or part of the nodes of the network receive the update data in order of the priority assigned to said nodes.

The invention relates to the command-control of equipment used in an electric distribution grid. Technically it involves intelligent equipment (of the type called “IED” for Intelligent Electronic Device) communicating via a command-control network (called “Smartgrid”), where each equipment unit forms a node of this command-control network.

In particular, the invention deals with operation and maintenance mechanisms for this equipment (mechanisms called “O&M”) and in particular mechanisms for updating firmware and/or updating various configuration files more generally for the management of the firmware functionalities of this equipment, and does so in all or part of the distributed equipment of the command-control network. Hereafter the terms “software update” designate both the update of the firmware and that of the configuration of the equipment.

The update of equipment in the command-control network can require manual sequencing. This applies both in the case of a configuration update and a firmware version update. To the extent where the various equipment units are interdependent, such coordination aims to stagger or even synchronize the updates (at different times for different equipment) in order to guarantee consistent operation between the equipment throughout the update mechanism.

In the case of a system where the equipment is instead independent of each other, such an ordering can additionally serve to stagger the updates over time, in order for a planned and/or optimized availability of the equipment, in order to better control the telecommunication channels and avoid their possible saturation.

The present invention aims to improve this situation.

For this purpose it proposes a method implemented by computer means for updating software intended to be executed by equipment of an electric distribution grid. Each equipment unit forms a node of the command-control network communicating with other nodes of the command-control network. In particular, the method comprises:
a first step in which the respective priorities for updating are assigned to the nodes of the command-control networks; and
a second step in which all or part of the nodes of the network receive the update data in order of the priority assigned to said nodes.

Thus, the invention serves to sequence the respective updates of the equipment of the network, according for example, to a hierarchy of nodes of the command-control network (for example from a root node out to leaf nodes) and/or again according to respective functionalities of the equipment in the electric distribution grid.

The method can be, in a specific implementation, implemented by a software update management system for the network equipment, at least depending on a topology of the command-control network and/or respective functionalities of the equipment in the electric distribution grid.

In a specific implementation, each node of the network stores the data item relative to the priority thereof at the outcome of the first step, and sends the priority data thereof to a software update management system for the network equipment for implementing the second step.

Of course, it involves an option. In an alternative variant, the aforementioned update management system can itself store the respective priority data for the equipment in a database, for example.

In the aforementioned specific implementation, upon receiving respective priority data from the nodes, the update management system determines an effective update sequence for the software in each node of the network according to the respective priorities assigned to said nodes.

These “effective” updates can target both the update of the software, once it is finished, and the execution of the software thus updated.

In a first embodiment, the software update comprises a network equipment firmware update.

In a second alternative for supplemental embodiment, the software update comprises a network equipment configuration update (for example by updating computer files which are used by the software which is executed by the equipment).

It will be thus understood that the term “software update” is understood to mean both a firmware update and an update of the computer files that the software uses, or even an update of any kind of software that the equipment more generally runs.

In the first aforementioned embodiment, the priority of a node for the firmware update can be defined by a data object relating to the logical node of type “LIFH” of the Common Data Class ING, according to the IEC 61850 standard.

In the second aforementioned embodiment, the priority of a node for the configuration update is defined by a data object relating to the logical node of type “LICH” of the Common Data Class ING, according to the IEC 61850 standard.

Such implementations, making use of the aforementioned standard, serve to homogenize the distribution of the information for the network node priority level and do so in a standardized way whatever the nature of the equipment and/or the manufacturer thereof.

The present invention also targets a system comprising:
at least one equipment software update management system for an electric distribution grid, for a software update intended to be executed by equipment in the electric distribution grid, where each equipment unit forms a node of the command-control network communicating with other nodes of the command-control network; and
one or more equipment units from the electric distribution grid.

In particular, the update management system comprises a computer circuit programmed to execute the steps of the method defined above.

The present invention also targets equipment for an electric distribution grid for such a system comprising in particular a computer circuit programmed for:
storing data about the priority of this equipment, and
sending this priority data on request to the software update management system for the network equipment.

The invention also targets an equipment software update management system for an electric distribution grid (each equipment unit forming a node of the command-control network communicating with other nodes of the command-control network). In particular, the update management system comprises a computer circuit programmed to:
assign the respective priorities for updating the nodes of the command-control networks; and
send update data to all or part of the nodes of the network in order of the priorities assigned to said nodes.

As an example, FIG. 7 shows such a computer circuit for the equipment or also for the aforementioned management system. Thus, in the example shown in FIG. 7, the computer circuit CT of each of these devices can typically comprise a communication interface COM with the command-control network SMG, connected to a processor PROC capable of executing operations corresponding to the steps of the above method. For this purpose, the processor PROC cooperates with a memory MEM storing in particular instructions for a computer program in the meaning of the invention, and also data for each priority level for example (for the network equipment). The processor PROC is further connected to an interface INT for driving an update of the software (the firmware in particular or the configuration file(s)) which a command module for the equipment CEQ executes in order to run the operation of the equipment.

The present invention also targets a computer program comprising instructions (which could be distributed between the various aforementioned equipment and system) for implementation of the method when this program is executed by a processor.

Other advantages and features of the invention will appear upon reading the detailed description of the embodiments presented below as nonlimiting examples and examining the attached drawings on which:

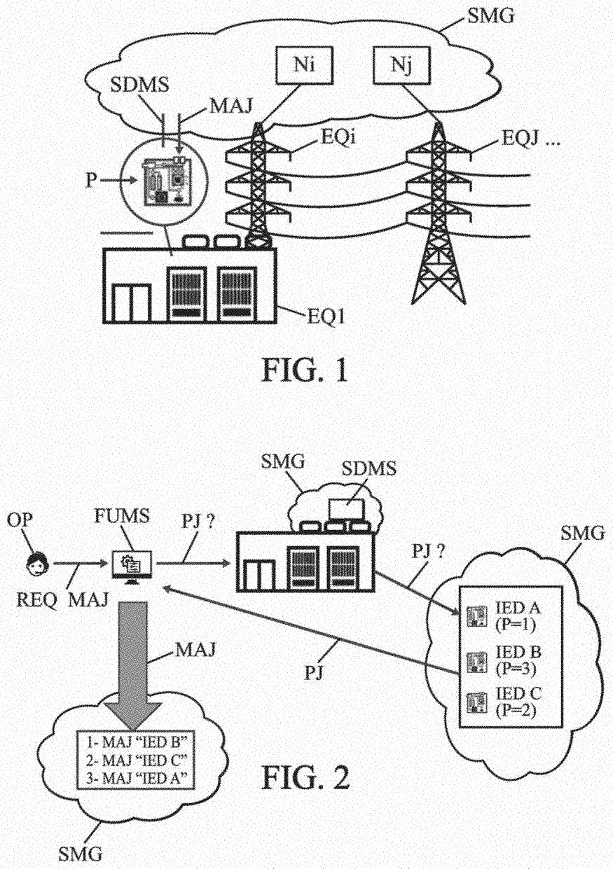

FIG. 1 schematically illustrates a system for implementing the invention;

FIG. 2 illustrates very schematically the system and equipment for the system which could implement the method in the meaning of the invention, according to a sample implementation;

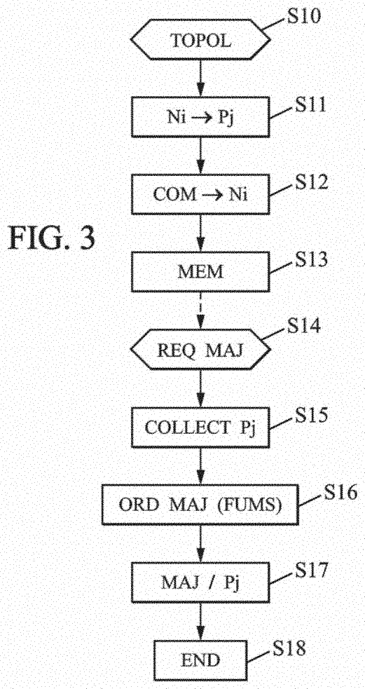

FIG. 3 schematically illustrates the steps of a method in the meaning of the invention, according to a sample implementation;

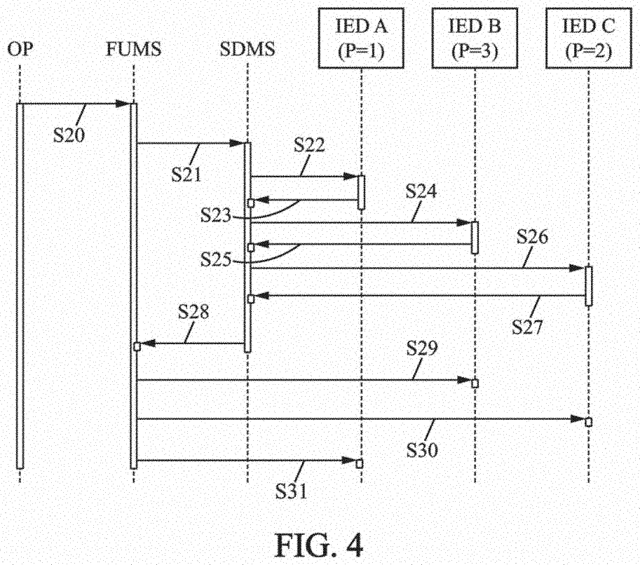

FIG. 4 is an example sequence diagram for a software update according to the method from FIG. 3.

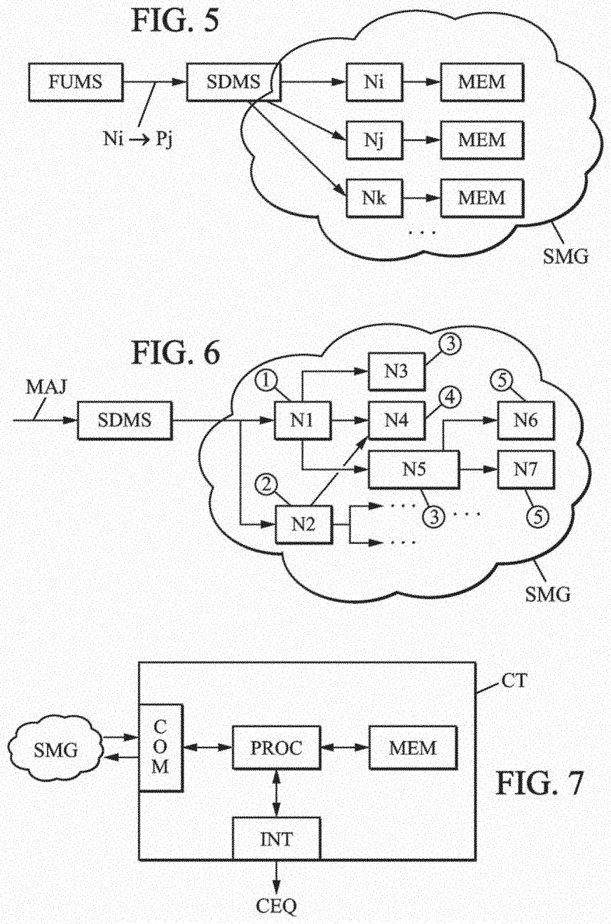

FIG. 5 schematically shows the system from FIG. 1 in a first global, initial step of the method;

FIG. 6 schematically shows the system from FIG. 1 in a second global, current step of the method;

FIG. 7 shows very schematically a type structure example for equipment or a management system for implementing the invention (both as equipment for which the software is to be updated or as management entity for these updates, where this system can more generally be responsible for maintenance operations for the network equipment).

The invention thus proposes a tool with which to automatically coordinate updates (of software in particular firmware and/or of configuration) for all equipment, and to do so almost in real time, without necessarily requiring the very detailed knowledge of the functionalities and specificities of each equipment unit of the command-control network at the time of these updates.

This tool already comprises the addition to the standard governing the command-control networks IEC-61850 of one or more variables describing a prioritization parameter for the updates.

In particular, in the internal data model for equipment according to the IEC-61850 standard, at least one attribute (two attributes in the example described) give(s) a priority level (for example a priority from 1 to 5) during firmware and configuration updates. This priority level is given for example in the form of an integer (between 1 and 5 inclusive, for example).

For example, the higher this priority level, the more the equipment must be given priority during update operations. This priority level is initially assigned to each current equipment during the initial configuration phase for this current equipment. Later, this level can be changed dynamically for this current equipment by a simple update of the data model thereof.

Equipment can therefore know its own update priority level, and do so in comparison with the other equipment connected to the command-control network.

With the various communication services allowed by the IEC-61850 standard, the priority information can be known not only by the equipment itself, but can also be accessible by one or more information devices using this priority data for management of the Smartgrid network.

FIG. 1 shows a set of equipment EQ1, EQi, EQj for an electricity distribution grid, such as for example an HVA/LV transformer substation, one or more poles that could have routers, out to leaf nodes of the grid (not shown). This equipment is called “smart” and in particular comprises means for communication between the equipment, within a Smartgrid SMG type telecommunication network. Thus each unit of this equipment EQ1, EQi, EQj can form an SDMS node Ni, Nj, etc. of the SMG grid.

For example, the SDMS reference from FIG. 1 can designate a central root node named “Smartgrid Device Management System,” which can for example receive priority levels P associated respectively with the equipment and send these priority level values to each node Ni, Nj, etc. downstream in the network to be stored there in the equipment.

Referring now to FIG. 5 illustrating this situation, these priority levels Pj for the nodes Ni of the Smartgrid network are established initially and/or dynamically. For example, these priority levels can be determined initially according to a topology of the network. As another example, these priorities can be determined dynamically with each installation of new equipment EQi.

The system initially in charge of defining these priorities can be, as a nonlimiting example, a FUMS (Firmware Update Management System) network management system, in particular in charge of updates of software (in particular firmware) that the equipment run and/or of the configuration thereof. This FUMS system may engage with the SDMS node for this purpose.

The SDMS node then sends each node Ni the priority level Pj which was defined by the FUMS system for the node Ni. Each node can then store the value of this priority level in memory MEM (for example a value ranging from 1 to 5).

Now referring to FIG. 6, the SDMS node upon receiving a software update request for the equipment, or alternatively the FUMS directly (as shown in the example from FIG. 2 discussed above) sends the nodes of the network the update data MAJ by order of the previously defined priority. Thus, in the example shown, the node has a higher priority (1) compared to the node N2 (priority (2)). The node N3, downstream from the node Ni, can logically have a priority lower (level (3)) than that of the node Ni. The node N4, also downstream from the node Ni, but having to receive update data both the first node N1 and the second node N2, is for its part assigned a lower priority (level (4)) than that of the node N3. Thus, it will be understood that implementing these priority level serves to order the transmission of the update data and possibly to do so from several upstream nodes N1, N2 for the single update of a downstream node N4. The node N5, located downstream from the node N1 like the node N3, can have the same priority level as the node N3 (level (3)). On the other hand, the nodes N6 and N7 which are downstream from the node N5 can again have a lower priority level (level (5)), etc.

As an example, FIG. 2 shows the update by an operator OP of the equipment of a command-control network made up of three equipment units in this example:
Equipment IED A which has a priority level P=1 (here the lowest),
IED B which has a priority level P=3 (here the highest),
IED C which has a priority level P=2 (second highest in this example).

The operator OP enters an update request (typically through a human machine interface) to an FUMS command-control management support system, where the FUMS system comprises a firmware and/or respective configuration update module for the equipment. The FUMS system can be connected to the SMG command-control network and directly request from the IED A, IED B and IED C equipment the priority order that it can then store in advance in memory. Alternatively, the FUMS system is connected to the SDMS root node at the head of the SMG command-control network, for example, but without limitation, the Smartgrid Device Management System (or SDMS) type node acting as a root central node, then collecting the priority orders (arrow “Pj?” downstream from the node SDMS in FIG. 2) from equipment through the SMG command-control network.

Again alternatively, the FUMS command-control management support system can store the priority order of the network equipment in memory without need for calling on the equipment in order to get it.

These priority orders could have been determined respectively at the installation of each network equipment unit, for example according to the topology of the network. The priority order assigned to this new equipment can be defined for example by the equipment installer according to the functionality of the equipment and the connection thereof to other equipment of the command-control network.

This step is then followed by storage in memory of the priority order thus assigned to the newly installed equipment (in the memory of the equipment, or directly in the FUMS system (or even possibly in the SMDS root node) for example upon receiving a successful installation message from the equipment, reported thereby to the FUMS entity and comprising a priority order defined by the installer).

Thus for firmware and/or configuration update, the FUMS system can access the priority order of the equipment affected by this update. Once this information is received (arrow “PJ” returning to the FUMS system), the FUMS system can then order the update (MAJ) as follows:
first that of the equipment IED B;
then that of the equipment IED C; and
finally that of the equipment IED A.

Now referring to FIG. 3 showing the steps of an example of the method according to the invention, implemented here by the FUMS system, a first step S10 consists of getting information on the topology of the network and, depending on this information, defining in step S11 the respective priority levels for all equipment associated with the nodes Ni of the Smartgrid network SMG. In step S12, the values of these priority levels are sent to these nodes Ni to be stored there in memory MEM in step S13.

Once this prior global step has been finished, for a current global step to update firmware and/or to update equipment configurations, the FUMS system receives in step S14 an update request from the operator OP, after which the FUMS entity collects in step S15 the priority orders Pj previously stored in the nodes Ni of the equipment. Depending on the priority levels Pj, the FUMS system is then able to prepare in step S16 a sequencing for the updates. In step S17, the FUMS system can send the update data according to this sequence, for example via the SDMS root node, in order to broadcast these update data via the root node out to the various affected nodes Ni of the SMG Smartgrid network. Once the update is installed, each affected node can send an end of update notification to the FUMS system and the method can stop at step S18 once all the affected nodes have been updated.

The sequence diagram in FIG. 4 shows more clearly the exchanges implemented in particular during the current overall step for an update. During the first step S20, the update operator OP for the command-control network sends an update request for the command-control network to the FUMS update management system, which asks the SDMS command-control node to collect the priority levels for all equipment in step S21.

Next, the SDMS root node individually queries:
a first equipment unit IED A in step S22 in order to get the priority level thereof and the node for the equipment IED A notifies the SMDS root node in step S23 of the priority level thereof (here P=1);
a second equipment unit IED B in step S24 in order to get the priority level thereof and the node for the equipment IED B notifies the SMDS root node in step S25 of the priority level thereof (here P=3 in the example described);
a first equipment unit IED C in step S26 in order to get the priority level thereof and the node for the equipment IED B notifies the SMDS root node in step S27 of the priority level thereof (here P=2); etc.

Next, once the SDMS root node has collected all these priority level values, the set of values can be reported in step S28 to the FUMS management system. Based on these respective priority level values, the FUMS system can order and then drive the updates for all equipment, in priority order:
first the node IED B in step S29 (for the most urgent, first priority P=3);
then the node IED C in step S30 (for the second priority P=2); and finally
the node IED A in step S31 (for the third priority P=1);

The use case is unchanged whether it involves a configuration or firmware update.

Further, this update sequencing can concretely also correspond to:
a sequencing of operations for downloading the update to the equipment; and/or
a sequencing of update activation operations in the equipment.

These two sequencing can be done concurrently or offset in time.

Further, as indicated above the sequencings can be defined according to the network topology (manually by an operator or automatically by a computer program as a function of the functionalities assigned and the connections for the equipment). For example, updating the configuration or firmware in an electric substation may require a sequencing during the activation phase of this new configuration/firmware in each equipment unit making up the substation and require it for associated reasons of security, hardware or software architecture, and dependence. For example, a medium voltage/low-voltage transformer substation (or “HVA/LV”) can be made up of three equipment units comprising a master IED unit and two “extension” IED units. The extension units are preferably updated before the master unit so as to assure service continuity in monitoring the substation. The priority level thus serves to define this ordering during the configuration phase and thereby drive this precise sequencing automatically.

Implementation of the present invention is seen in particular by a change of the data model according to the IEC 61850 standard comprising in particular two new “data object” type parameter variables with which to assign a sequencing priority level to each equipment unit for the firmware and configuration update sequence (one object for the firmware update and one object for the configuration update).

The parts of the standard affected by this change can for example be:
IEC 61850-7-4 (“Basic communication structure—Compatible logical node classes and data object classes”); and
IEC-61850-90-16 (“Using IEC 61850 for System Management purposes”).

More specifically, the two new objects to be defined can be “Integer Status Setting” type introduced in Part 7-3 of the same standard.

For example, in the “Logical Node LICH” (“LICH” for “Logical IED Configuration Handling”) class, a new Data Object type parameter named for example “ConfUpdPrioLvl” (for “Configuration Update Priority Level”) can be defined with “Common Data Class: Integer Status Setting” (abbreviated by “ING”) class, as shown in the following table.

| | | | | |
|---|---|---|---|---|
| Data object name | Common data class | Explanation | T | M/O/C |

| | | | |
|---|---|---|---|
| CfgUpdPrioLvl | ING | Configuration | O |
| | | update priority | |
| | | level | |

Similarly, in the “Logical Node LIFH” (IED Firmware Handling) class, a new Data Object type parameter named for example “FwUpdPrioLvl” (for “Configuration Update Priority Level”) can be defined with “Common Data Class: Integer Status Setting” (abbreviated by “ING”) class, as shown in the following table.

| | | | | |
|---|---|---|---|---|
| Data object name | Common data class | Explanation | T | M/O/C |

| | | | |
|---|---|---|---|
| FwUpdPrioLvl | ING | Firmware update | O |
| | | priority level | |

Generally, the present invention is not limited to the embodiments described above as an example; it extends to other variants.

Thus, it will be understood for example that updating the software for the equipment can be sequenced by the FUMS management system as detailed above, or else alternatively by the SDMS root node which then receives in this alternative implementation the update data from the FUMS system and sends it by priority order according to the collected priority levels.

Again alternatively, the data can be sent simultaneously to all equipment with respective update start instructions for each equipment unit for starting these updates at the moment indicated in these instructions.

1: A method implemented by computer means for updating software intended to be executed by equipment of an electrical distribution grid, where each equipment unit forms a node of a command-control network communicating with other nodes of this command-control network,
the method comprising:
a first step in which the respective priorities for updating are assigned to the nodes of the command-control networks; and
a second step in which all or part of the nodes of the network receive the update data in order of the priority assigned to said nodes,
and wherein, each node of the network stores the data item relative to the priority thereof at the outcome of the first step, and sends the priority data thereof to a software update management system for the network equipment for implementing the second step.

2: The method according to claim 1 implemented by a software update management system for the network equipment, at least depending on a topology of the command-control network and/or respective functionalities of the equipment in the electric distribution grid.

3: The method according to claim 1, wherein upon receiving respective priority data from the nodes, said update management system determines an effective update sequence for the software in each node of the network according to the respective priorities assigned to said nodes.

4: The method according to claim 1, wherein software update comprises a network equipment firmware update.

5: The method according to claim 1, wherein software update comprises a network equipment configuration update.

6: The method according to claim 4, wherein the priority of a node for the firmware update is defined by a data object relating to the logical node of type “LIFH” of the Common Data Class ING, according to the IEC 61850 standard.

7: The method according to claim 5, wherein the priority of a node for the configuration update is defined by a data object relating to the logical node of type “LICH” of the Common Data Class ING, according to the IEC 61850 standard.

8: A system for updating software intended to be executed by equipment of an electrical distribution grid, where each equipment unit forms a node of a command-control network communicating with other nodes of this command-control network, the system comprising:
at least one equipment software update management system for an electric distribution grid, for doing said software update; and
one or more equipment units from the electric distribution grid,
said update management system comprising a computer circuit programmed to execute the steps of the method according to claim 1.

9: Equipment for an electric distribution grid for a system according to claim 8, comprising in particular a computer circuit programmed for:
storing data about the priority of said equipment, and
sending said priority data on request to the software update management system for the network equipment.

10: An equipment software update management system for an electric distribution grid, each equipment unit forming a node of the command-control network communicating with other nodes of the command-control network, said update management system comprising a computer circuit programmed to:
assign the respective priorities for updating the nodes of the command-control networks; and
send update data to all or part of the notes of the network in order of the priorities assigned to said notes.

11: A non-transitory computer medium storing instructions of a computer program for implementing the method according to claim 1, when this computer program is executed by a processor.
